(19) United States
(12) Patent Application Publication
(10) Pub. No.: US 2015/0193336 A1
(43) Pub. Date: Jul. 9, 2015

(54) COMPUTING DEVICE AND METHOD FOR RECORDING SYSTEM EVENT LOGS OF COMPUTING DEVICE

(71) Applicants: HON HAI PRECISION INDUSTRY CO., LTD., New Taipei (TW); HONG FU JIN PRECISION INDUSTRY (ShenZhen) CO., LTD., ShenZhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/147,620

(22) Filed: Jan. 6, 2014

(51) Int. Cl. G06F 12/02

(52) U.S. Cl. CPC G06F 12/0246; G06F 2212/2022

(57) ABSTRACT

In a method for recording system event logs of a computing device, the computing device includes a storage device and a baseboard management controller (BMC). The computing device generates an inquiring command to inquire an actual number of the system event logs that are recorded in a flash memory of the BMC. When the actual number of the system event logs is equal to the maximum number of the system event logs, the system event logs are copied from the flash memory and saved to the storage device, and the system event logs are deleted from the flash memory. The inquiring command is resent to the BMC to continue recording the system event logs in the flash memory if the computing device has not completed a stability performance test on the computing device.

### BACKGROUND

1. Technical Field

Embodiments of the present disclosure relate to information recording systems and methods, and particularly to a computing device and a method for recording system event logs of the computing device.

2. Description of Related Art

Computing devices (e.g., personal computers or servers) used in a variety of applications inevitably incur errors during operations, for example due to failures of software or hardware components. Such failures may pass unnoticed until their cumulative effects degrade system performance to such an extent that corrective action must be taken. Often, when corrective action becomes necessary, the failures may be difficult to detect because they may be related to some past operation or system state which cannot be recorded. Because the failures may not be detectable, it may not be possible to rectify these failures, and therefore the failures persist in the computing devices. Accordingly, a method and system are needed for recording information to enable de-bugging of system problems occurred in the computing devices.

### BRIEF DESCRIPTION OF THE DRAWINGS

FIG. 1 is a block diagram of one embodiment of a computing device comprising a system event log recording system.

FIG. 2 is a flowchart of one embodiment of a method for recording system event logs of the computing device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium comprise CDs, DVDs, flash memory, and hard disk drives.

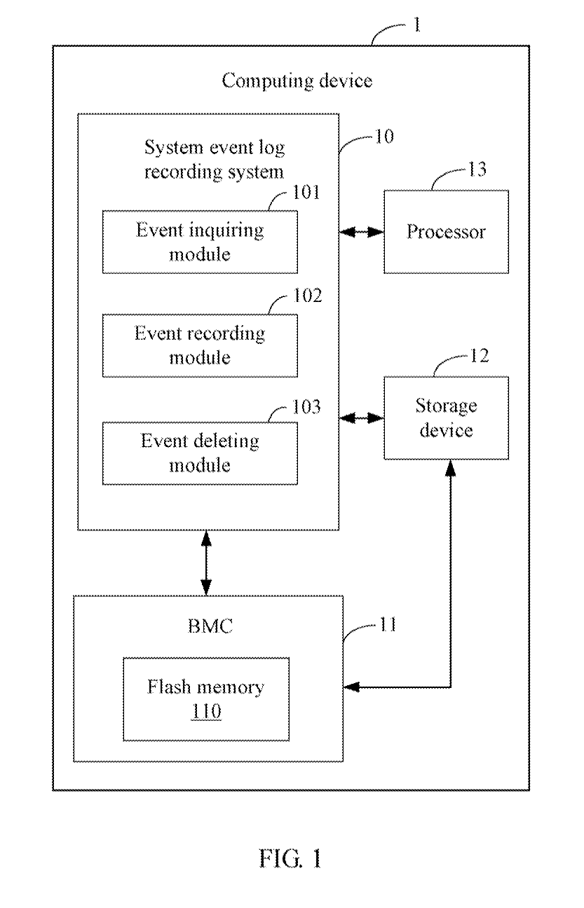

FIG. 1 is a block diagram of one embodiment of a computing device 1 comprising a system event log recording system 10. In the embodiment, the computing device 1 further comprises, but is not limited to, a baseboard management controller (BMC) 11, a storage device 12, and at least one processor 13. The system event log recording system 10 comprises computerized instructions in the form of one or more computer-readable programs, which are implemented by the at least one processor 13 of the computing device 1. In one embodiment, the computing device 1 can be a personal computer, a server computer, a workstation computer, or other data processing device. FIG. 1 is only one example of the computing device 1, and other examples may comprise more or fewer components than those shown in the embodiment, or have a different configuration of the various components.

The BMC 11 comprises a flash memory 110 that is used to store system event logs generated by the computing device 1 during a process of testing a stability performance of the computing device 1. In one embodiment, the system event logs comprise, but are not limited to, a system log indicating a high system voltage, a system log indicating a low fan speed, a system log indicating a high CPU usage ratio, and a system log indicating a high system temperature.

In one embodiment, the storage device 12 can be an internal storage system, such as a flash memory, a random access memory (RAM) for temporary storage of information, and/or a read-only memory (ROM) for permanent storage of information. The storage device 12 can also be an external storage system, such as an external hard disk, a storage card, or a data storage medium. The at least one processor 13 can be a central processing unit (CPU), a microprocessor, or other data processor chip that performs various functions of the computing device 1.

In one embodiment, the system event log recording system 10 comprises, but is not limited to, an event inquiring module 101, an event recording module 102, and an event deleting module 103. The modules 101-103 may comprise computerized instructions in the form of one or more computer-readable programs that are stored in a non-transitory computer-readable medium (such as the storage device 12) and executed by the at least one processor 13 of the computing device 1. A description of each module is given in the following paragraphs.

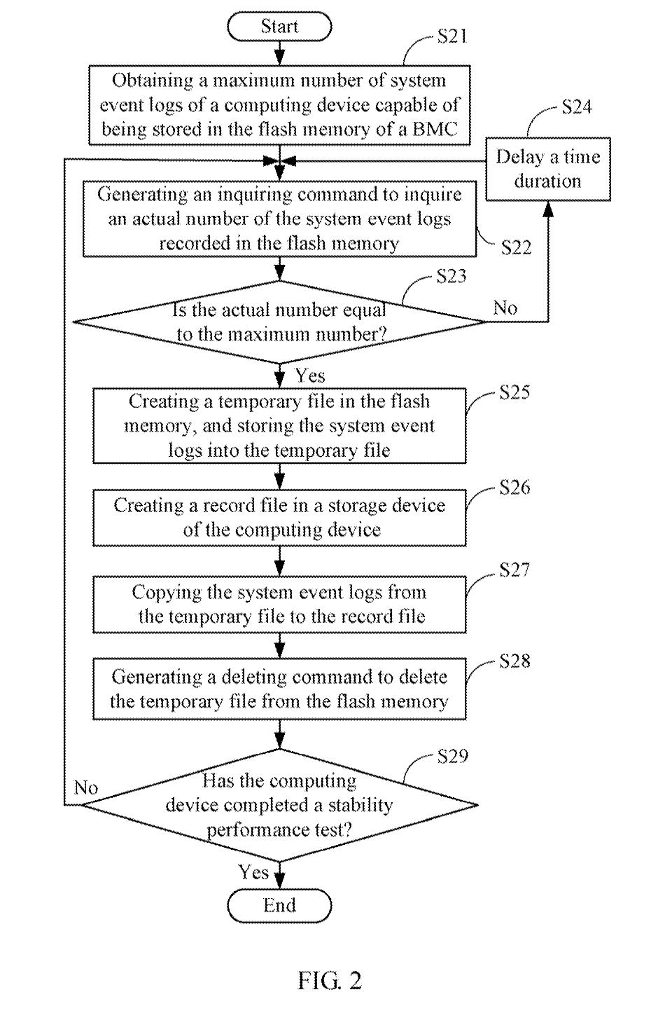

FIG. 2 is a flowchart of one embodiment of a method for recording system event logs of the computing device 1. In one embodiment, the method is performed by execution of computer-readable software program codes or instructions by the at least one processor 13 of the computing device 1. Depending on the embodiment, additional steps may be added, others removed, and the ordering of the steps may be changed.

In step S21, the event inquiring module 101 obtains a maximum number of system event logs of the computing device 1 capable of being stored in the flash memory 110. In the embodiment, the computing device 1 generates various system event logs during the process of testing a stability performance of the computing device 1, and records the system event logs in the flash memory 110. The maximum number is predefined according to a storage capacity of the flash memory 110. For example, if the storage capacity of the flash memory 110 is ten megabytes, then one hundred system event logs can be recorded in the flash memory 110. In one embodiment, the system event logs comprise a system log indicating a high system voltage, a system log indicating a low fan speed, a system log indicating a high CPU usage ratio, and a system log indicating a high system temperature.

In step S22, the event inquiring module 101 generates an inquiring command to inquire an actual number of the system event logs of the computing device 1 that are recorded in the flash memory 110. In the embodiment, the event inquiring module 101 sends the inquiring command to the BMC 11, and obtains the actual number of the system event logs that are recorded in the flash memory 110 according to the inquiring command.

In step S23, the event inquiring module 101 determines whether the actual number of the system event logs is less than or equal to the maximum number of the system event logs. If the actual number of the system event logs is less than the maximum number of the system event logs, step S24 is implemented. Otherwise, if the actual number of the system event logs is equal to the maximum number of the system event logs, step S25 is implemented.

In step S24, the event inquiring module 101 delays a predetermined time duration (e.g., 30 seconds), and resends the inquiring command to the BMC 11 to continue inquiring the actual number of the system event logs that are recorded in the flash memory 110.

In step S25, the event recording module 102 creates a temporary file in the flash memory 110, and stores the system event logs into the temporary file. In the embodiment, the temporary file can be a text file or other suitable format file.

In step S26, the event recording module 102 creates a record file in the storage device 12 of the computing device 1. In the embodiment, the record file can also be a text file or other suitable format file.

In step S27, the event recording module 102 copies the system event logs from the temporary file to the record file. In the embodiment, the event recording module 102 obtains the system event logs from the temporary file stored in the flash memory 110, and saves the system event logs into the record file stored in the storage device 12. The system event logs are stored in the storage device 12 through the BMC 11, so that all of the system event logs can be recorded without taking up the storage capacity of the flash memory 110 of the BMC 11.

In step S28, the event deleting module 103 generates a deleting command to delete the temporary file from the flash memory 110 of the BMC 11. In the embodiment, the BMC 11 deletes all the system event logs recorded in the temporary file from the flash memory 110 according to the deleting command.

In step S29, the event deleting module 103 determines whether the computing device 1 has completed the stability performance test on the computing device 1. If the computing device 1 has not completed the stability performance test on the computing device 1, the process goes back to step S22. Otherwise, if the computing device 1 has completed the stability performance test on the computing device 1, the procedure ends.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a baseboard management controller (BMC) comprising a flash memory;
at least one processor; and
a storage device storing a computer-readable program comprising instructions that, which when executed by the at least one processor, causes the at least one processor to:
obtain a maximum number of system event logs of the computing device capable of being stored in the flash memory;
generate an inquiring command to inquire an actual number of the system event logs of the computing device that are recorded in the flash memory;
determine whether the actual number of the system event logs is less than or equal to the maximum number of the system event logs;
copy the system event logs of the computing device from the flash memory to the storage device when the actual number of the system event logs is equal to the maximum number of the system event logs;
generate a deleting command to delete the system event logs from the flash memory;
determine whether the computing device has completed a stability performance test on the computing device; and
resend the inquiring command to the BMC to continue recording the system event logs in the flash memory when the computing device has not completed the stability performance test on the computing device.

2. The computing device according to claim 1, wherein the computer-readable program further causes the at least one processor to:
delay a predetermined time duration and resend the inquiring command to the BMC to continue inquiring the actual number of the system event logs that are recorded in the flash memory, when the actual number of the system event logs is less than the maximum number of the system event logs.

3. The computing device according to claim 1, wherein the system event logs are copied from the flash memory to the storage device by performing steps of:
creating a temporary file in the flash memory, and storing the system event logs into the temporary file;
creating a record file in the storage device of the computing device; and
obtaining the system event logs from the temporary file stored in the flash memory, and saving the system event logs into the record file stored in the storage device.

4. The computing device according to claim 3, wherein either the temporary file or the record file is a text file.

5. The computing device according to claim 1, wherein the system event logs comprise a system log indicating a high system voltage, a system log indicating a low fan speed, a system log indicating a high CPU usage ratio, and a system log indicating a high system temperature.

6. A method for recording system event logs of a computing device, the computing device comprising a storage device and a baseboard management controller (BMC) comprising a flash memory, the method comprising:
obtaining a maximum number of system event logs of the computing device capable of being stored in the flash memory;
generating an inquiring command to inquire an actual number of the system event logs of the computing device that are recorded in the flash memory;
determining whether the actual number of the system event logs is less than or equal to the maximum number of the system event logs;
copying the system event logs of the computing device from the flash memory to the storage device when the actual number of the system event logs is equal to the maximum number of the system event logs;
generating a deleting command to delete the system event logs from the flash memory;
determining whether the computing device has completed a stability performance test on the computing device; and
resending the inquiring command to the BMC to continue recording the system event logs in the flash memory when the computing device has not completed the stability performance test on the computing device.

7. The method according to claim 6, further comprising:
delaying a predetermined time duration and resending the inquiring command to the BMC to continue inquiring the actual number of the system event logs that are recorded in the flash memory, when the actual number of the system event logs is less than the maximum number of the system event logs.

8. The method according to claim 6, wherein the system event logs are copied from the flash memory to the storage device by performing steps of:
creating a temporary file in the flash memory, and storing the system event logs into the temporary file;
creating a record file in the storage device of the computing device; and
obtaining the system event logs from the temporary file stored in the flash memory, and saving the system event logs into the record file stored in the storage device.

9. The method according to claim 8, wherein either the temporary file or the record file is a text file.

10. The method according to claim 6, wherein the system event logs comprise a system log indicating a high system voltage, a system log indicating a low fan speed, a system log indicating a high CPU usage ratio, and a system log indicating a high system temperature.

11. A non-transitory storage medium having stored thereon instructions that, when executed by at least one processor of a computing device, causes the processor to perform a method for recording system event logs of the computing device, the computing device comprising a storage device and a baseboard management controller (BMC) comprising a flash memory, the method comprising:
obtaining a maximum number of system event logs of the computing device capable of being stored in the flash memory;
generating an inquiring command to inquire an actual number of the system event logs of the computing device that are recorded in the flash memory;
determining whether the actual number of the system event logs is less than or equal to the maximum number of the system event logs;
copying the system event logs of the computing device from the flash memory to the storage device when the actual number of the system event logs is equal to the maximum number of the system event logs;
generating a deleting command to delete the system event logs from the flash memory;
determining whether the computing device has completed a stability performance test on the computing device; and
resending the inquiring command to the BMC to continue recording the system event logs in the flash memory when the computing device has not completed the stability performance test on the computing device.

12. The storage medium according to claim 11, wherein the method further comprises:
delaying a predetermined time duration and resending the inquiring command to the BMC to continue inquiring the actual number of the system event logs that are recorded in the flash memory, when the actual number of the system event logs is less than the maximum number of the system event logs.

13. The storage medium according to claim 11, wherein the system event logs are copied from the flash memory to the storage device by performing steps of:
creating a temporary file in the flash memory, and storing the system event logs into the temporary file;
creating a record file in the storage device of the computing device; and
obtaining the system event logs from the temporary file stored in the flash memory, and saving the system event logs into the record file stored in the storage device.

14. The storage medium according to claim 13, wherein either the temporary file or the record file is a text file.

15. The storage medium according to claim 11, wherein the system event logs comprise a system log indicating a high system voltage, a system log indicating a low fan speed, a system log indicating a high CPU usage ratio, and a system log indicating a high system temperature.
